(19) United States
(12) Patent Application Publication
(10) Pub. No.: US 2004/0108769 A1
(43) Pub. Date: Jun. 10, 2004

(54) Automatic secondary brake application

(76) Inventor: Sameer S. Marathe, Oswego, IL (US)

Correspondence Address: CATERPILLAR INC., 100 N.E. ADAMS STREET, PATENT DEPT., PEORIA, IL, 616296490

(21) Appl. No.: 10/310,712

(22) Filed: Dec. 5, 2002

(51) Int. Cl. B60T 13/74

(52) U.S. Cl. 303/2; 303/122; 188/106 P

(57) ABSTRACT

During operation of a vehicle, an operator actuates a primary brake system to slow or stop the vehicle. The present invention detects when the primary brake system is not retarding vehicle motion as desired and responsively applies a secondary brake system. The secondary brake system is provided as a backup to the primary brake system.

### TECHNICAL FIELD

The present invention is of the form of a secondary brake control system for a vehicle and, more particularly, to a secondary brake control system which detects when a primary brake is ineffective and responsively applies a secondary brake.

### BACKGROUND

A vehicle, such as an automobile, work machine, on- or off-highway truck, or the like is equipped with a primary brake system. This primary brake system may be automatically applied, but is generally actuated instead by a device adapted to produce an operator primary brake signal responsive to an operator's command such as, for example, a brake pedal or lever. The primary brake system is usually powered by a mechanical linkage, a hydraulic or pneumatic system, an electrical circuit, or a combination of these.

The vehicle also commonly includes a secondary brake system, often referred to as a “parking” or “emergency” brake. The secondary brake system may be powered the same way as the primary brake system, or may have any other suitable source of power, preferably one separated from the power for the primary brake system in case of a power failure. The secondary brake system is not constructed or intended to be used to routinely slow or stop the vehicle and therefore should not normally be used during regular vehicle operation.

When the operator of the vehicle desires to reduce a travel speed of the vehicle, he produces the operator primary brake signal by manipulating the appropriate primary brake control device (referenced hereafter as depressing a brake pedal). The operator primary brake signal is then passed to the primary brake system and the primary brake system slows the vehicle as desired by the operator. However, if the primary brake system fails or is otherwise not operative to adequately reduce the vehicle speed, the operator must manually actuate the secondary brake system. In a situation requiring the vehicle to stop abruptly, unavailability of the primary brake system may cause the operator to panic and be unable to actuate the secondary brake system in time to avoid a collision. It is therefore desirable to provide a system which controls the secondary brake system to serve as an automatically actuated backup to the primary brake system.

U.S. Pat. No. 3,982,792, issued Sep. 28, 1976 to Norio Nakajima (hereafter referenced as '792) discloses an emergency brake system which detects a differential in pressure at two different points in the hydraulic conduits of the primary brake system. If the pressure differential is greater than a predetermined amount, the primary brake is considered to have failed and the pressure differential causes a switch to open and actuate the secondary brake. However, the mechanical nature of the '792 device leaves the device vulnerable to mechanical failures. The switch also may be physically located within the brake system such that it cannot be easily replaced or adjusted to change the response of the '792 system. Finally, the response of the '792 device cannot be changed in reaction to another vehicle characteristic.

The present invention is directed to overcoming one or more of the problems as set forth above.

### SUMMARY OF THE INVENTION

In a preferred embodiment of the present invention, an automatic secondary brake application method is disclosed. The method includes the steps of: actuating a primary brake; monitoring at least one primary brake operation characteristic; comparing the monitored primary brake operation characteristic to a predetermined primary brake characteristic value; and actuating a secondary brake responsive to a result of the comparison of the primary brake operation characteristic and the predetermined primary brake characteristic value.

In a preferred embodiment of the present invention, an automatic secondary brake application system is disclosed. The system includes a primary brake system, at least one primary brake operation characteristic monitor adapted to produce a primary brake operation characteristic signal, and a secondary brake system. The system also includes an electronic control module adapted to control the primary brake system, receive the primary brake operation characteristic signal, compare the primary brake operation characteristic signal to a predetermined primary brake characteristic value, and control the secondary brake system responsive to a result of the comparison between the primary brake operation characteristic signal and the predetermined primary brake characteristic value.

In a preferred embodiment of the present invention, a vehicle is disclosed. The vehicle includes a vehicle body, a ground engaging system including at least one wheel and providing motive power to the vehicle body, and an automatic secondary brake application system. The automatic secondary brake application system includes a primary brake system adapted to resist the motive power of the ground engaging system; a primary brake interface adapted to produce an operator primary brake signal; at least one primary brake operation characteristic monitor adapted to produce a primary brake operation characteristic signal; a secondary brake system adapted to resist the motive power of the ground engaging system; and an electronic control module adapted to receive the operator primary brake signal and responsively control the primary brake system, receive the primary brake operation characteristic signal, compare the primary brake operation characteristic signal to a predetermined primary brake characteristic value, and control the secondary brake system responsive to a result of the comparison between the primary brake operation characteristic signal and the predetermined primary brake characteristic value.

### BRIEF DESCRIPTION OF THE DRAWINGS

FIG. 1 is a schematic of a vehicle including a preferred embodiment of the present invention.

### DETAILED DESCRIPTION

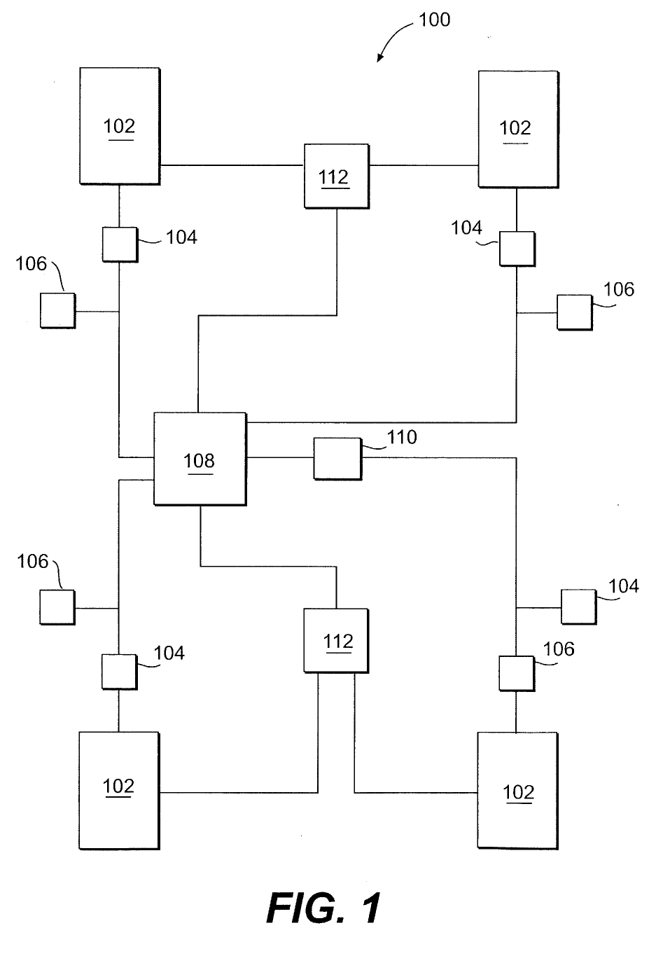

FIG. 1 depicts a vehicle 100, which may be of a standard configuration including a vehicle body and an operator compartment (both not shown) or may have any other suitable configuration. A ground-engaging system includes at least one wheel 102 and provides motive power to the vehicle 100. The vehicle 100 includes an automatic secondary brake application system, shown generally in FIG. 1.

The automatic secondary brake application system includes a primary brake system 104, shown and discussed herein as a primary brake 104 of any suitable type associated with each wheel 102. At least one primary brake operation characteristic is monitored by a primary brake operation characteristic monitor 106, and one or more primary brake operation characteristic monitors 106 are associated with the vehicle 100. For example, FIG. 1 includes a primary brake operation characteristic monitor 106 associated with each wheel 102. The primary brake operation characteristic monitors 106 need not measure directly a property of the primary brake 104 itself, and may be any type of sensor or other monitoring device, such as mechanical linkage position sensors, wheel speed or vehicle speed sensors, vehicle deceleration sensors/timers, hydraulic pressure or flow sensors, or any other suitable devices. For simplicity, the following description assumes a vehicle speed sensor 106.

No matter what primary brake operation characteristic is being monitored, the primary brake operation characteristic monitor 106 responsively produces a corresponding primary brake operation characteristic signal. This primary brake operation characteristic signal is received by an electronic control module (“ECM”) 108. Preferably, the ECM 108 is also adapted to control the primary brake system 104, either automatically or in response to an operator primary brake signal produced by an operator-manipulable primary brake interface 110 such as a brake pedal, lever, dial, or the like.

The ECM 108 compares the primary brake operation characteristic signal to a predetermined primary brake characteristic value. This predetermined primary brake characteristic value may be taken from any one or combination of a chart, equation, look-up table, set value, clock or timing device, or any other suitable source. The predetermined primary brake characteristic value is a value, or a range of two or more values, indicative of the expected value of the primary brake operation characteristic signal when the primary brake system 104 is functioning properly. Optionally, a primary brake status signal is produced to indicate whether or not the primary brake operation characteristic signal coincides with the predetermined primary brake characteristic value.

If the primary brake status signal and/or a result of the comparison between the primary brake operation characteristic signal and the predetermined primary brake characteristic value is unsatisfactory—that is, if the primary brake operation characteristic signal differs significantly from the predetermined primary brake characteristic value—the ECM 108 assumes that the primary brake system 104 is malfunctioning and activates a secondary brake system 112 to resist motion of the vehicle 100. The ECM 108 may also monitor or analyze the primary brake operation characteristic value to avoid activating the secondary brake system 112 in case of a failure of the brake operation characteristic monitor 106. This could be accomplished, for example, by comparing the outputs of two or more brake operation characteristic monitors 106. The secondary brake system 112 (shown here as the common configuration of one brake mechanism acting upon each pair of wheels 102) is preferably powered and operated differently than the primary brake system 104 so as to provide a redundant backup device. The primary brake system 104 could be of the electrohydraulic type and the secondary brake system 112 could be mechanically actuated, for instance.

Once the secondary brake system 112 is actuated, the motive power from the ground-engaging device is overcome and the vehicle 100 speed should be reduced without intervention from the operator.

### INDUSTRIAL APPLICABILITY

A preferred embodiment of an automatic secondary brake application procedure according to the present invention will now be discussed in detail. The inclusion or exclusion of certain components or primary brake operation characteristics below is not to be construed as limiting the present invention, as defined by the claims.

During travel of the vehicle 100, the operator, desiring to slow or stop the vehicle 100, depresses a brake pedal or otherwise manipulates the primary brake interface 110 to produce the operator primary brake signal. The ECM 108 receives the operator primary brake signal and responsively actuates the primary brake system 104. At least one primary brake operation characteristic monitor 106, assumed in this example to be a vehicle speed sensor 106, provides a primary brake operation characteristic signal to the ECM 108.

The ECM 108 automatically compares the primary brake operation characteristic signal to a predetermined primary brake characteristic value, which may be a single value or a range of values as mentioned above and may be obtained by the ECM 108 using any suitable procedure. If the primary brake operation characteristic signal does not coincide sufficiently with the predetermined primary brake characteristic value, the ECM 108 responsively actuates the secondary brake system 112. It is intuitively obvious that the relationship of the primary brake operation characteristic signal with the predetermined primary brake characteristic value need not be specified at this time, as a lower limit value, upper limit value, excluded range, included range, or any other format of the predetermined primary brake characteristic value is equally acceptable in the present invention and can be easily determined for a particular vehicle 100 and/or braking application.

With the vehicle speed sensor 106 providing a vehicle speed value to the ECM 108, deceleration of the vehicle 100 over time can be readily obtained in a known manner using a historical vehicle speed record and a timing device. If the vehicle 100 deceleration is substantially less than expected (as discovered by comparison to a predetermined vehicle 100 deceleration value or range), the primary brake system 102 is assumed to have failed and the secondary brake system 112 is actuated without further action by the operator. An “error range” may be implemented in the comparison to avoid the secondary brake system 112 being actuated in response to an insignificant difference in the comparison of the values.

To avoid the secondary brake system 112 being actuated in a situation such as descending a hill, when the deceleration due to the primary brake system 104 may be less than expected due to the influence of gravity, a weighting factor may be included in the predetermined primary brake characteristic value so that only a marked difference of the primary brake operation characteristic signal causes the secondary brake system 112 to actuate. This weighting factor may be the same as or different than the error range discussed above. In this case, an incline sensor may also or instead be made available so that an incline predetermined primary brake characteristic value may be used as one of the predetermined primary brake characteristic values when the incline sensor detects an inclined vehicle 100 condition.

It is also conceivable that this automatic secondary brake application system might only be used if the primary brake interface 110 indicates a sudden and/or substantial operator brake command. For example, only actuating the automatic secondary brake application system if the brake pedal is in the last fifth of its available travel would be another way to avoid actuation of the secondary brake system 112 in a case of the operator “riding” the brake pedal to lightly apply the primary brake system 104 on an incline. Also, a sudden actuation might indicate that the operator stomped on the brake pedal 110, perhaps in response to an obstacle in the vehicle's 100 path and a quick stop is needed to prevent an accident, making an uncompensated primary brake system 104 failure quite undesirable.

Other aspects, objects and advantages of the present invention can be obtained from a study of the drawings, the disclosure and the appended claims.

What is claimed is:

1. An automatic secondary brake application method, comprising:
actuating a primary brake;
monitoring at least one primary brake operation characteristic;
comparing the monitored primary brake operation characteristic to a predetermined primary brake characteristic value; and
actuating a secondary brake responsive to a result of the comparison of the primary brake operation characteristic and the predetermined primary brake characteristic value.

2. The method of claim 1, including:
producing a primary brake status signal responsive to the result of comparison of the primary brake operation characteristic and the predetermined primary brake characteristic value;
wherein actuation of the secondary brake is responsive to the primary brake status signal.

3. The method of claim 1, including:
producing an operator primary brake signal; and
controlling the primary brake responsive to the operator primary brake signal.

4. The method of claim 1, wherein the at least one primary brake operation characteristic is at least one of a mechanical linkage position, a vehicle speed, a wheel speed, and a vehicle deceleration.

5. The method of claim 1, wherein the step of monitoring at least one primary brake operation characteristic includes:
detecting a primary brake operation characteristic and responsively producing a primary brake operation characteristic signal.

6. The method of claim 2, wherein the step of comparing the monitored primary brake operation characteristic to a predetermined primary brake characteristic value and responsively producing a primary brake status signal includes:
receiving the primary brake operation characteristic signal;
predetermining the predetermined primary brake characteristic value using at least one of a chart, an equation, a look-up table, a set value, an incline sensor, and a timing device; and
producing the primary brake status signal responsive to the primary brake operation characteristic signal being different from the predetermined primary brake characteristic value.

7. The method of claim 1, wherein the predetermined primary brake characteristic value encompasses a range of values.

8. The method of claim 1, wherein the step of comparing the monitored primary brake operation characteristic to a predetermined primary brake characteristic value includes:
comparing a sensed vehicle deceleration value to an expected vehicle deceleration value; and
actuating the secondary brake responsive to the sensed vehicle deceleration value being lower than the expected vehicle deceleration value.

9. The method of claim 8, wherein the expected vehicle deceleration value includes a weighting factor.

10. An automatic secondary brake application system, comprising:
a primary brake system;
at least one primary brake operation characteristic monitor adapted to produce a primary brake operation characteristic signal;
a secondary brake system; and
an electronic control module adapted to control the primary brake system, receive the primary brake operation characteristic signal, compare the primary brake operation characteristic signal to a predetermined primary brake characteristic value, and control the secondary brake system responsive to a result of the comparison between the primary brake operation characteristic signal and the predetermined primary brake characteristic value.

11. The automatic secondary brake application system of claim 10, including a primary brake interface adapted to produce an operator primary brake signal, wherein the electronic control module is adapted to receive the operator primary brake signal and responsively control the primary brake system.

12. The automatic secondary brake application system of claim 10, wherein the at least one primary brake operation characteristic monitor is at least one of a mechanical linkage position sensor, a vehicle speed sensor, a wheel speed sensor, and a vehicle deceleration sensor.

13. The automatic secondary brake application system of claim 10, wherein the predetermined primary brake characteristic value is taken from at least one of a chart, an equation, a look-up table, a set value, an incline sensor, and a timing device.

14. The automatic secondary brake application system of claim 10, wherein the predetermined primary brake characteristic value encompasses a range of values.

15. The automatic secondary brake application system of claim 10, wherein the primary brake operation characteristic monitor produces a primary brake operation characteristic signal corresponding to at least one of an actual wheel speed and an actual vehicle speed, the primary brake operation characteristic signal is compared to a predetermined primary brake characteristic value corresponding to at least one of a desired wheel speed and a desired vehicle speed, and the electronic control module actuates the secondary brake in response to the primary brake operation characteristic signal being higher than the predetermined primary brake characteristic value.

16. A vehicle, comprising:
a vehicle body;
a ground engaging system including at least one wheel and providing motive power to the vehicle body; and
an automatic secondary brake application system, including:
a primary brake system adapted to resist the motive power of the ground engaging system;
a primary brake interface adapted to produce an operator primary brake signal;
at least one primary brake operation characteristic monitor adapted to produce a primary brake operation characteristic signal;
a secondary brake system adapted to resist the motive power of the ground engaging system; and
an electronic control module adapted to receive the operator primary brake signal and responsively control the primary brake system, receive the primary brake operation characteristic signal, compare the primary brake operation characteristic signal to a predetermined primary brake characteristic value, and control the secondary brake system responsive to a result of the comparison between the primary brake operation characteristic signal and the predetermined primary brake characteristic value.

17. The vehicle of claim 16, wherein the at least one primary brake operation characteristic monitor is at least one of a mechanical linkage position sensor, a vehicle speed sensor, a wheel speed sensor, and a vehicle deceleration sensor.

18. The vehicle of claim 16, wherein the predetermined primary brake characteristic value is taken from at least one of a chart, an equation, a look-up table, a set value, an incline sensor, and a timing device.

19. The vehicle of claim 16, wherein the predetermined primary brake characteristic value encompasses a range of values.

20. The vehicle of claim 16, wherein the primary brake operation characteristic monitor produces a primary brake operation characteristic signal corresponding to at least one of an actual wheel speed and an actual vehicle speed, the primary brake operation characteristic signal is compared to a predetermined primary brake characteristic value corresponding to at least one of a desired wheel speed and a desired vehicle speed, and the electronic control module actuates the secondary brake in response to the primary brake operation characteristic signal being higher than the predetermined primary brake characteristic value.
